(19) United States
(12) Patent Application Publication
(10) Pub. No.: US 2013/0021492 A1
(43) Pub. Date: Jan. 24, 2013

(54) IMAGE PROCESSING DEVICE, IMAGE PROCESSING METHOD, AND SOLID-STATE IMAGING DEVICE

(71) Applicants: Yukiyasu Tatsuzawa, Kanagawa (JP); Tatsuji Ashitani, Kanagawa (JP); Shiroshi Kanemitsu, Kanagawa (JP)

(72) Inventors: Yukiyasu Tatsuzawa, Kanagawa (JP); Tatsuji Ashitani, Kanagawa (JP); Shiroshi Kanemitsu, Kanagawa (JP)

(73) Assignee: Kabushiki Kaisha Toshiba, Tokyo (JP)

(21) Appl. No.: 13/418,685

(22) Filed: Mar. 13, 2012

(30) Foreign Application Priority Data
Jul. 19, 2011 (JP) 2011-157987

(51) Int. Cl. H04N 5/228

(52) U.S. Cl. 348/222.1; 348/E05.031

(57) ABSTRACT

According to embodiments, an image processing device includes a line-exposure selecting unit. The line-exposure selecting unit is capable of switching a pattern of selecting a first exposure time and a second exposure time. The second exposure time is shorter than the first exposure time. The line-exposure selecting unit switches the pattern according to at least one of a frame rate required of a synthetic image and an image size required of a synthetic image.

### CROSS-REFERENCE TO RELATED APPLICATIONS

This application is based upon and claims the benefit of priority from Japanese Patent Application No. 2011-157987, filed on Jul. 19, 2011; the entire contents of all of which are incorporated herein by reference.

### FIELD

The present embodiments typically relate to an image processing device, an image processing method, and a solid-state imaging device.

### BACKGROUND

Conventionally, there is proposed a technology that realizes a wide dynamic range (WDR) operation by using pixel groups with different exposure time. In a portion in which incident light intensity is less, a pixel group with a long exposure time can obtain image information having an excellent contrast compared with a pixel group with a short exposure time. In the pixel group with a long exposure time, charges obtained by photoelectric conversion reach a storage capacity of a photodiode in some cases in a portion in which incident light intensity is high. When such saturation of output occurs with respect to incident light intensity, gradation according to incident light intensity cannot be obtained, so that output characteristics degrade. Therefore, the pixel group with a short exposure time is used for a portion in which incident light intensity is high, so that image reproducibility can be ensured. A solid-state imaging device can obtain a WDR image by synthesizing portions, in which excellent output characteristics are obtained, with each other in an image.

In order to match an output level between the pixel group with a long exposure time and the pixel group with a short exposure time, a solid-state imaging device multiplies a signal value obtained in the pixel group with a short exposure time by a predetermined gain. The gain, for example, corresponds to an exposure-time ratio between both pixel groups with different exposure time.

In the case of a WDR operation in which exposure time is made different for each line, for a saturated pixel in which output is saturated in the pixel group with a long exposure time, an interpolation process of using signal values of pixels located around the saturated pixel in the pixel group with a short exposure time is performed. In this case, whereas an image size does not change due to a WDR operation, the resolution in the vertical direction becomes substantially half compared with a normal case in a portion of the saturated pixel, so that image quality degrades.

Moreover, in still image capturing or the like, a WDR operation of using a plurality of images captured while changing exposure time is put to practical use. With this method, the problem in image quality is solved, however, the frame rate of a synthetic image delays with respect to the output period by an image sensor. Therefore, this method is difficult to be applied to moving image capturing in which the frame rate needs to be prioritized.

### BRIEF DESCRIPTION OF THE DRAWINGS

FIG. 1 is a block diagram illustrating a schematic configuration of a solid-state imaging device according to a first embodiment;

FIG. 2 is a block diagram illustrating a configuration of a camera module including the solid-state imaging device shown in FIG. 1;

FIG. 3 is a diagram illustrating output characteristics of a long-exposure pixel and a short-exposure pixel and output characteristics after a WDR operation;

FIG. 4 is a diagram explaining a WDR operation in a first operation pattern;

FIG. 5 is a diagram explaining a WDR operation in a second operation pattern;

FIG. 6 is a diagram explaining interpolation on a signal value of a saturated pixel;

FIG. 7 is a block diagram illustrating a schematic configuration of a solid-state imaging device according to a second embodiment;

FIG. 8 is a diagram explaining a WDR operation in a third operation pattern; and

FIG. 9 is a diagram explaining a WDR operation in a fourth operation pattern.

### DETAILED DESCRIPTION

According to embodiments, an image processing device includes a line-exposure selecting unit and an image synthesizing unit. The line-exposure selecting unit selects any of a first exposure time and a second exposure time to be applied to each pixel forming a pixel array of an image sensor. The second exposure time is shorter than the first exposure time. The line-exposure selecting unit selects any of the first exposure time and the second exposure time for each line of the pixel array. The image synthesizing unit performs interpolation on a signal value of a saturated pixel by using signal values of second pixels. The saturated pixel is a pixel in which saturation of output occurs with respect to incident light intensity among first pixels. The first pixel is a pixel to which the first exposure time is applied. The second pixel is a pixel to which the second exposure time is applied. The image synthesizing unit obtains a synthetic image by synthesizing a first image signal and a second image signal. The first image signal is an image signal obtained from the first pixels. The second image signal is an image signal obtained from the second pixels. The line-exposure selecting unit can switch a pattern of selecting the first exposure time and the second exposure time. The line-exposure selecting unit switches the pattern according to at least one of a frame rate required of the synthetic image and an image size required of the synthetic image.

An image processing device, an image processing method, and a solid-state imaging device according to the embodiments will be explained in detail below with reference to the accompanying drawings. The present invention is not limited to these embodiments.

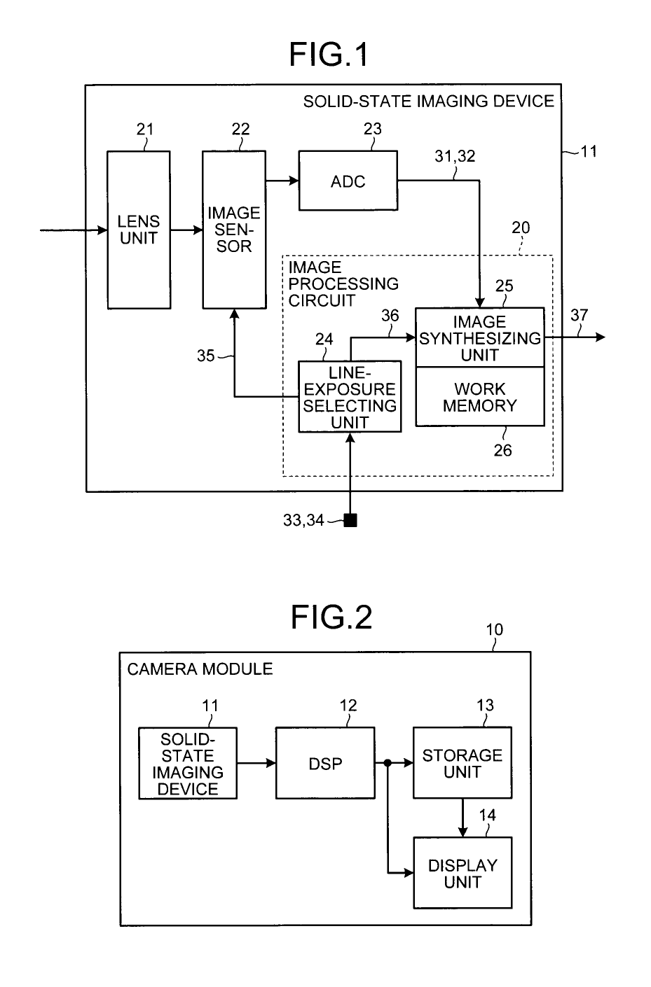

FIG. 1 is a block diagram illustrating a schematic configuration of a solid-state imaging device according to a first embodiment. FIG. 2 is a block diagram illustrating a configuration of a camera module including the solid-state imaging device shown in FIG. 1. A camera module 10 is, for example, a digital camera. The camera module 10 may be an electronic device other than a digital camera, and may be, for example, a mobile terminal with camera.

The camera module 10 includes a solid-state imaging device 11, a digital signal processor (DSP) 12, a storage unit 13, and a display unit 14. The solid-state imaging device 11 captures a subject image. The DSP 12 performs a signal process of an image signal obtained by imaging in the solid-state imaging device 11. For example, the DSP 12 performs shading correction, auto exposure (AE) adjustment, auto white balance (AWB) adjustment, a matrix process, edge enhancement, luminance compression, a gamma process, and the like on a RAW image input from the solid-state imaging device 11.

The storage unit 13 stores therein images subjected to a signal process in the DSP 12. The storage unit 13 outputs an image signal to the display unit 14 according to an operation by a user or the like. The display unit 14 displays an image according to an image signal input from the DSP 12 or the storage unit 13. The display unit 14 is, for example, a liquid crystal display.

The solid-state imaging device 11 includes an image processing circuit (image processing device) 20, a lens unit 21, an image sensor 22, and an analog-digital converter (ADC) 23. The lens unit 21 captures light from a subject and forms a subject image on the image sensor 22.

The image sensor 22 converts light captured by the lens unit 21 to signal charges to capture a subject image. The image sensor 22 generates an analog image signal by capturing signal values of RGB in order corresponding to a Bayer array. The ADC 23 converts an image signal from the image sensor 22 from an analog form to a digital form.

The image processing circuit 20 performs a signal process of an image signal from the ADC 23. The image processing circuit 20 includes a line-exposure selecting unit 24, an image synthesizing unit 25, and a work memory 26. The line-exposure selecting unit 24 selects any of a first exposure time and a second exposure time to be applied to each pixel forming the pixel array of the image sensor 22 for each line of the pixel array. The image sensor 22 has a configuration capable of selecting any of the first exposure time and the second exposure time to be applied to each pixel forming the pixel array for each line. The second exposure time is shorter than the first exposure time.

The image synthesizing unit 25 obtains a synthetic image by synthesizing a first image signal 31 obtained from long-exposure pixels and a second image signal 32 obtained from short-exposure pixels. The image synthesizing unit 25 outputs a WDR synthetic image signal 37. The long-exposure pixel is a first pixel to which the first exposure time is applied. The short-exposure pixel is a second pixel to which the second exposure time is applied. The work memory 26 appropriately stores therein an image signal input to the image synthesizing unit 25.

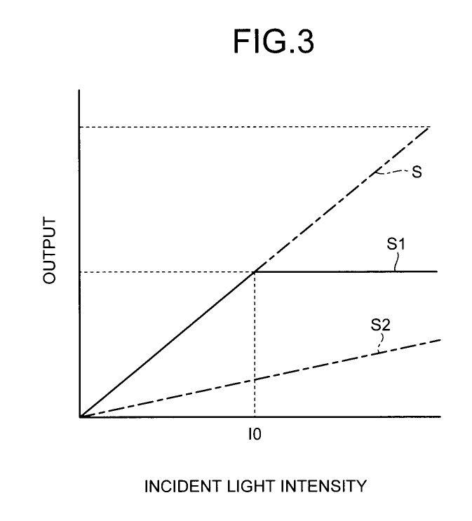

FIG. 3 is a diagram illustrating output characteristics of the long-exposure pixel and the short-exposure pixel and output characteristics after a WDR operation. When incident light intensity is I0, signal charges generated by photoelectric conversion reach a storage capacity of a photodiode in the long-exposure pixel. When incident light intensity is I0 or lower, an output S1 of the long-exposure pixel increases in proportion to increase of incident light intensity. When incident light intensity is larger than I0, the output S1 of the long-exposure pixel saturates and becomes constant. When incident light intensity is larger than I0 also, an output S2 of the short-exposure pixel increases in proportion to increase of incident light intensity.

Under the environment in which incident light intensity is I0 or lower, the ratio of output to incident light intensity becomes high in the long-exposure pixel compared with the short-exposure pixel. Therefore, under the low illumination environment, an image with excellent contrast can be obtained in the long-exposure pixel compared with the short-exposure pixel. Under the environment in which incident light intensity becomes larger than I0, the output S1 of the long-exposure pixel saturates, however, the output S2 of the short-exposure pixel becomes a level according to incident light intensity.

The image synthesizing unit 25 synthesizes the output S1 of the long-exposure pixel when incident light intensity is I0 or lower and the output S2 of the short-exposure pixel when incident light intensity is larger than I0. The image synthesizing unit 25 obtains an output S by multiplying the output S2 of the short-exposure pixel by a gain equivalent to the ratio of an exposure amount to the output S1 of the long-exposure pixel. The image synthesizing unit 25 synthesizes the output S1 of the long-exposure pixel and the output S of the short-exposure pixel.

For example, when an image signal output from the image sensor 22 is 10 bits and a gain can be selected from 4 times, 8 times, and 16 times, the image processing circuit 20 can obtain 12 bits, 13 bits, and 14 bits as the number of output bits for a synthetic image.

Frame rate information 33 and image size information 34 are input to the solid-state imaging device 11. The frame rate information 33 is information indicating a frame rate required of a synthetic image output from the solid-state imaging device 11. The image size information 34 is information indicating an image size required of a synthetic image output from the solid-state imaging device 11.

In the image processing circuit 20, a plurality of operation patterns, in which a WDR operation is performed, is preset. The line-exposure selecting unit 24 outputs a line selection signal 35 and a pattern identification signal 36 according to an operation pattern selected according to the frame rate information 33 and the image size information 34.

The line selection signal 35 is a signal indicating which any of the first exposure time and the second exposure time is selected for each line of the pixel array. The line-exposure selecting unit 24 can switch a pattern of selecting the first exposure time and the second exposure time by the line selection signal 35. The image sensor 22 sorts each line of the pixel array into a line of the long-exposure pixel and a line of the short-exposure pixel according to the line selection signal 35. The pattern identification signal 36 is a signal for identifying an operation pattern.

Next, each operation pattern of a WDR operation by the image processing circuit 20 is explained. In this example, the pixel size of the image sensor 22 is 3840×2160 pixels (8.3 megapixels) and the frequency, at which an image signal can be output from the pixel size, is 30 fps (frame per second).

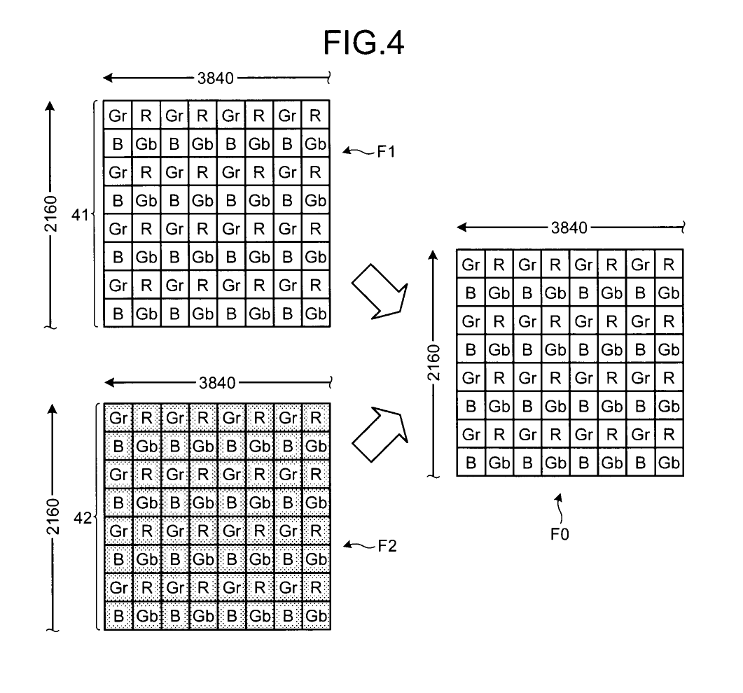

FIG. 4 is a diagram explaining a WDR operation in a first operation pattern. The first operation pattern is applied when the image size corresponding to the number of pixels included in the pixel array is required and the frame rate corresponding to a half of the frequency, at which an image signal can be output from the pixel array, is required. In this example, the image size required of a synthetic image is 3840×2160 pixels and the frame rate required of a synthetic image is 15 fps. The first operation pattern is, for example, suitable for capturing still images.

A Bayer array is composed of four pixels of Gr, R, Gb, and B as a unit. An R pixel is a pixel for detecting R light. A B pixel is a pixel for detecting B light. Gr pixel and Gb pixel are pixels for detecting G light. Gr pixels are in juxtaposition with R pixels in a line. Gb pixels are in juxtaposition with B pixels in a line.

In a first frame F1, the line-exposure selecting unit 24 outputs the line selection signal 35 indicating selection of the first exposure time for all lines. In the first frame F1, the image processing circuit 20 sets all pixels of the pixel array to a long-exposure pixel 41. The image sensor 22 generates the first image signal 31 by long exposure of the full screen according to the line selection signal 35. The image synthesizing unit 25 temporarily stores the first image signal 31 input from the image sensor 22 via the ADC 23 in the work memory 26.

In a second frame F2 next to the first frame F1, the line-exposure selecting unit 24 outputs the line selection signal 35 indicating selection of the second exposure time for all lines. In the second frame F2, the image processing circuit 20 sets all pixels of the pixel array to a short-time exposure pixel 42. The image sensor 22 generates the second image signal 32 by short exposure of the full screen according to the line selection signal 35.

The image synthesizing unit 25 performs a synthesizing process by the first operation pattern according to the pattern identification signal 36 indicating the first operation pattern. When the first line of the second image signal 32 is input for the second frame F2, the image synthesizing unit 25 starts reading the first image signal 31 from the work memory 26. Moreover, the image synthesizing unit 25 multiplies a signal level of the second image signal 32 by a gain.

The image synthesizing unit 25 performs interpolation on a signal value of a saturated pixel, in which saturation of output occurs among the long-exposure pixels 41, by using signal values of the short-time exposure pixels 42. When there is a saturated pixel, the image synthesizing unit 25 switches a signal value of the first image signal 31 of this pixel to a signal value of the second image signal 32 after being multiplied by a gain. Because the phase (position) of the image of the first frame F1 matches that of the second frame F2, the image synthesizing unit 25 can perform interpolation on gradation of a portion in which saturation occurs by applying the second image signal 32 multiplied by a gain directly to a saturated pixel.

The image synthesizing unit 25 applies the first image signal 31 to a portion in which saturation does not occur. The image synthesizing unit 25 synthesizes the first image signal 31 of the first frame F1 and the second image signal 32 of the second frame F2 by an interpolation process on a saturated pixel and outputs the obtained WDR synthetic image signal 37. In the first operation pattern, a synthetic frame F0 is obtained by using the first and second frames F1 and F2, so that the frame rate of the solid-state imaging device 11 becomes 15 fps that is a half of the frequency at which an image signal can be output by the image sensor 22.

The solid-state imaging device 11 can maintain the resolution of a pixel size of the image sensor 22, for example, equivalent to 8.3 megapixels by a WDR operation by the first operation pattern. The solid-state imaging device 11 can obtain high-quality still images by prioritizing fineness of images over the imaging rate.

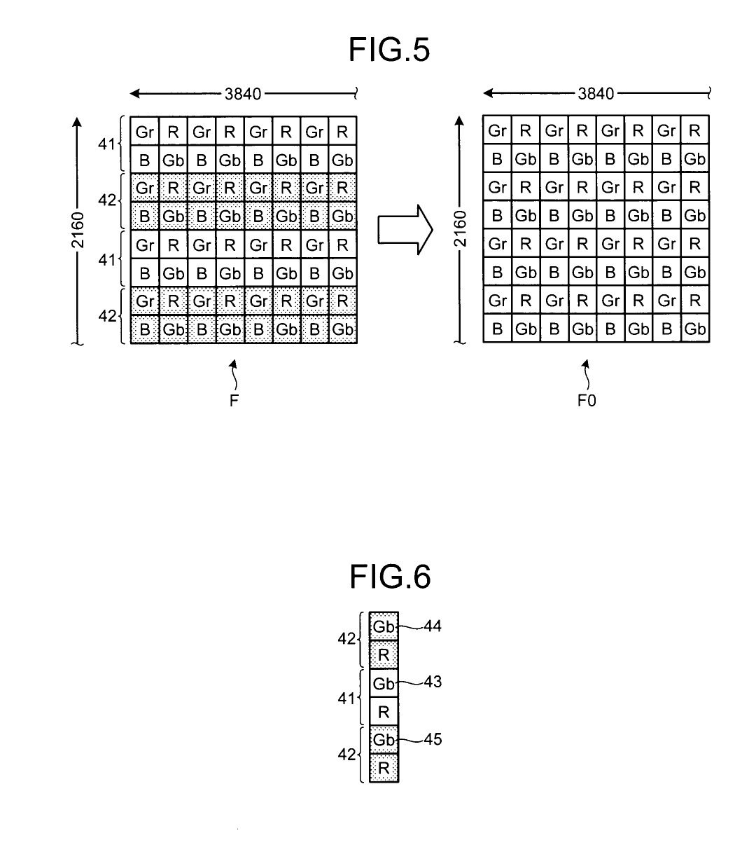

FIG. 5 is a diagram explaining a WDR operation in a second operation pattern. The second operation pattern is applied when the image size corresponding to the number of pixels included in the pixel array is required and the frame rate corresponding to the frequency, at which an image signal can be output from the pixel array, is required. In this example, the image size required of a synthetic image is 3840×2160 pixels and the frame rate required of a synthetic image is 30 fps. The second operation pattern is, for example, suitable for a case of reducing the effect of camera shake in still image capturing.

The line-exposure selecting unit 24 outputs the line selection signal 35 for selecting the first exposure time and the second exposure time alternately every two lines. The image processing circuit 20 alternately sets the long-exposure pixels 41 for two lines and the short-time exposure pixels 42 for two lines. The image sensor 22 performs the long exposure and the short exposure every two lines according to the line selection signal 35. The image sensor 22 generates the first image signal 31 from the long-exposure pixels 41 and the second image signal 32 from the short-time exposure pixels 42.

The image synthesizing unit 25 performs a synthesizing process by the second operation pattern according to the pattern identification signal 36 indicating the second operation pattern. The image synthesizing unit 25 multiplies a signal level of the second image signal 32 by a gain. The image synthesizing unit 25 synthesizes the first image signal 31 for two lines and the second image signal 32 multiplied by the gain for two lines alternately.

FIG. 6 is a diagram explaining interpolation on a signal value of a saturated pixel. The image synthesizing unit 25 performs interpolation on a signal value of a saturated pixel by using signal values of the short-time exposure pixels 42 located around the saturated pixel. For example, a Gb pixel 43 among the long-exposure pixels 41 is a saturated pixel. Two Gb pixels 44 and 45 juxtaposed to the Gb pixel 43 in a vertical direction with one R pixel therebetween are both the short-time exposure pixel 42. The image synthesizing unit 25, for example, calculates an average of signal values of the two Gb pixels 44 and 45 after being multiplied by a gain and sets it as an interpolation value of the Gb pixel 43. Consequently, the image synthesizing unit 25 performs interpolation on gradation of a portion in which saturation occurs.

The image synthesizing unit 25 is not limited to the case of performing an interpolation process of using two short-time exposure pixels 42 with respect to one saturated pixel. The image synthesizing unit 25 may perform an interpolation process of using three or more short-time exposure pixels 42 located around one saturated pixel with respect to the saturated pixel. Moreover, the image synthesizing unit 25 may perform an interpolation process by any conventionally-known method.

After performing an interpolation process on a saturated pixel, the image synthesizing unit 25 synthesizes the first image signal 31 and the second image signal 32 for a single frame F and outputs the obtained WDR synthetic image signal 37. In the second operation pattern, because the synthetic frame F0 is obtained by using a single frame F, the frame rate of the solid-state imaging device 11 becomes 30 fps that is the same as the frequency at which an image signal can be output by the image sensor 22.

The solid-state imaging device 11 can maintain the frame rate corresponding to the output frequency of the image sensor 22 by a WDR operation by the second operation pattern. The solid-state imaging device 11 can effectively suppress the effect of camera shake by enabling high-speed imaging according to the output period of the image sensor 22.

In a WDR operation, the resolution of an image and the frame rate have a trade-off relationship. The image processing circuit 20 can obtain a WDR image with optimized image quality and frame rate according to the needs in imaging by enabling switching of a pattern in a WDR operation according to the image size and the frame rate required of a synthetic image.

The line-exposure selecting unit 24 is not limited to the case of enabling switching of a pattern of selecting the long exposure and the short exposure according to both the frame rate information 33 and the image size information 34. It is sufficient that the line-exposure selecting unit 24 can switch a pattern of selecting the long exposure and the short exposure according to at least one of the frame rate information 33 and the image size information 34. Consequently, the image processing circuit 20 can perform a WDR operation suitable for the needs in imaging.

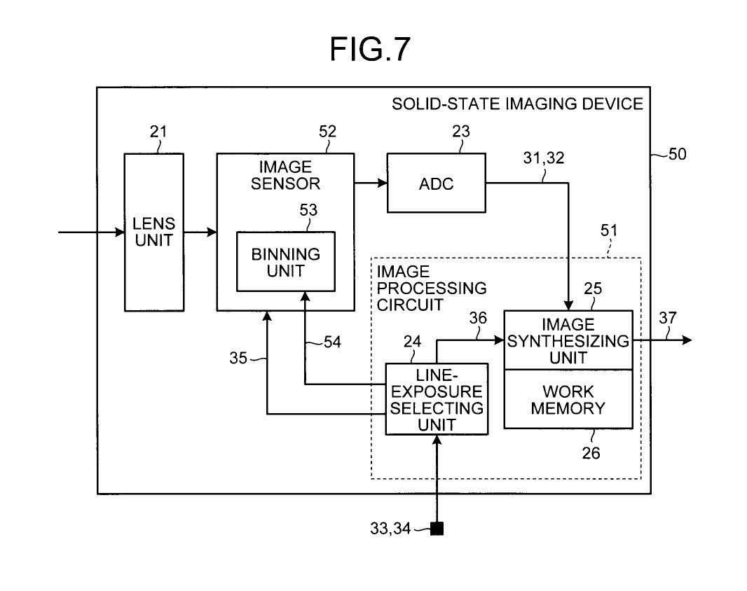

FIG. 7 is a block diagram illustrating a schematic configuration of a solid-state imaging device according to a second embodiment. A solid-state imaging device 50 according to the present embodiment is applied to the camera module 10 (see FIG. 2). Parts same as those in the first embodiment are denoted by the same reference numerals and overlapping explanation is appropriately omitted.

The solid-state imaging device 50 includes an image processing circuit (image processing device) 51, the lens unit 21, an image sensor 52, and the analog-digital converter (ADC) 23. The image sensor 52 includes a binning unit 53. The binning unit 53 performs a binning process for reading out an image signal while regarding a region formed of a predetermined number of juxtaposed pixels in the pixel array as one light receiving surface.

The image processing circuit 51 outputs a binning signal 54 in addition to the line selection signal 35 and the pattern identification signal 36. The binning signal 54 is a signal indicating a binning process by the binning unit 53. The line-exposure selecting unit 24 outputs the binning signal 54 according to an operation pattern selected according to the frame rate information 33 and the image size information 34.

In the image processing circuit 51, third and fourth operation patterns of a WDR operation are preset in addition to the first and second operation patterns in the first embodiment.

Next, the third and fourth operation patterns of a WDR operation by the image processing circuit 51 are explained. In this example, in the similar manner to the first embodiment, the pixel size of the image sensor 52 is 3840×2160 pixels and the frequency, at which an image signal can be output from the pixel size, is 30 fps.

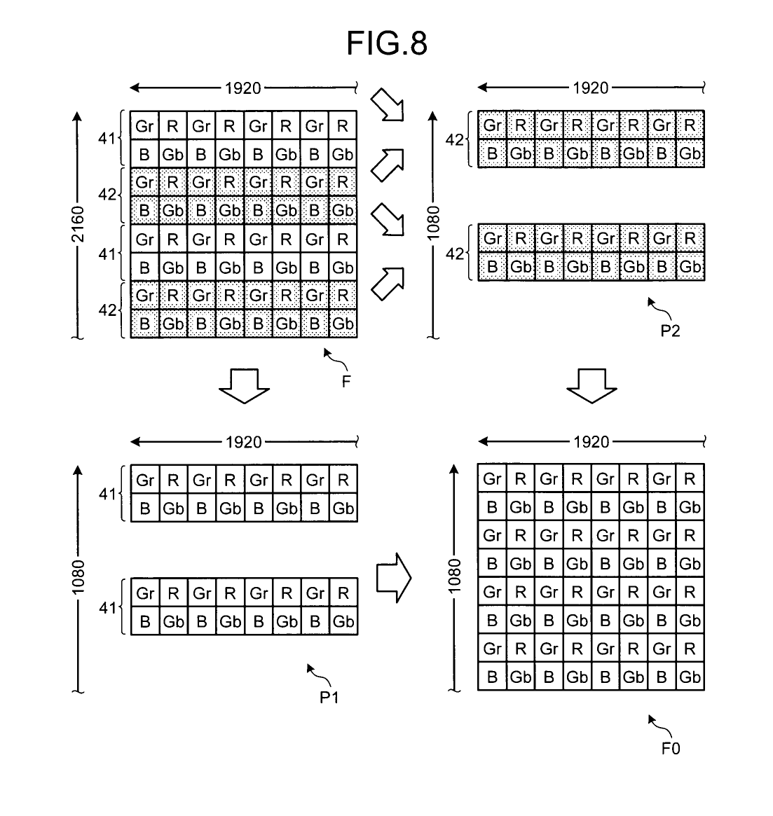

FIG. 8 is a diagram explaining a WDR operation in the third operation pattern. The third operation pattern is applied when the image size smaller than the number of pixels included in the pixel array is required and the frame rate corresponding to the frequency, at which an image signal can be output from the pixel array, is required. In this example, the image size required of a synthetic image is 1920×1080 pixels and the frame rate required of a synthetic image is 30 fps. The third operation pattern is, for example, suitable for capturing moving image.

The line-exposure selecting unit 24 instructs to perform a binning process of reading out an image signal while regarding two pixels juxtaposed in the horizontal direction as one pixel, by the binning signal 54. The binning unit 53 performs a binning process in which the number of pixels in the horizontal direction is regarded as a half, according to the binning signal 54. The image sensor 52 captures an image with a ratio obtained by extending a normal aspect ratio by a factor of two in the vertical direction. In this example, the image sensor 52 outputs an image signal subjected to a binning process from 3840×2160 pixels to 1920×2160 pixels.

Moreover, in the similar manner to the second operation pattern, the line-exposure selecting unit 24 outputs the line selection signal 35 for selecting the first exposure time and the second exposure time alternately every two lines. The image processing circuit 51 alternately sets the long-exposure pixels 41 for two lines and the short-time exposure pixels 42 for two lines. The image sensor 52 performs the long exposure and the short exposure every two lines according to the line selection signal 35. The image sensor 52 generates the first image signal 31 from the long-exposure pixels 41 and the second image signal 32 from the short-time exposure pixels 42.

The image synthesizing unit 25 performs a synthesizing process by the third operation pattern according to the pattern identification signal 36 indicating the third operation pattern. The image synthesizing unit 25 decomposes a single frame F into a long exposure image P1 of 1920×1080 pixels obtained from the long-exposure pixels 41 and a short exposure image P2 of 1920×1080 pixels obtained from the short-time exposure pixels 42. Moreover, for the short exposure image P2, the image synthesizing unit 25 multiplies a signal level by a gain in the similar manner to the first embodiment.

There is a phase difference for two lines in the vertical direction between the long exposure image P1 and the short exposure image P2. The image synthesizing unit 25 matches the phase of the short exposure image P2 to the phase of the long exposure image P1 by adjusting the phase of the short exposure image P2 in the vertical direction with reference to the long exposure image P1.

The image synthesizing unit 25, for example, performs phase adjustment of the short exposure image P2 by calculating an average of signal values for two lines of the short-time exposure pixels 42 located on the upstream side of the long-exposure pixels 41 for two lines in the vertical direction and two lines of the short-time exposure pixels 42 located on the downstream side in the vertical direction in the frame F. A method of phase adjustment of the short exposure image P2 by the image synthesizing unit 25 can be appropriately changed.

The image synthesizing unit 25 sets a phase of the first image signal 31, which is obtained from the long-exposure pixels 41 enabling high-definition imaging compared with the short-time exposure pixel 42, to be constant. In the second image signal 32, the SN ratio (signal-to-noise ratio) with respect to the first image signal 31 tends to degrade. Phase adjustment of the second image signal 32 in the image synthesizing unit 25 is equivalent to a filter process, so that the SN ratio is improved in addition to leading to the possibility of reducing the resolution. The image processing circuit 51 can maintain high quality in exchange for slight reduction of the resolution by performing such phase adjustment in the image synthesizing unit 25.

The long exposure image P1 for two lines and the short exposure image P2 after phase adjustment for two lines are arranged alternately on the image sensor 52. The image synthesizing unit 25 compresses the long exposure image P1 and the short exposure image P2 after phase adjustment to a half in the vertical direction. The solid-state imaging device 50 can obtain an image with a normal aspect ratio through compression in the image synthesizing unit 25 by capturing in advance an image with a ratio obtained by extending a normal aspect ratio by a factor of two in the vertical direction by the image sensor 52.

In the similar manner to the first operation pattern, the image synthesizing unit 25 performs interpolation on a signal value of a saturated pixel, in which saturation of output occurs among the long-exposure pixels 41, by using signal values of the short-time exposure pixels 42. When there is a saturated pixel, the image synthesizing unit 25 switches a signal value of the first image signal 31 for this pixel to a signal value of the second image signal 32 after being multiplied by a gain. In this manner, the image synthesizing unit 25 synthesizes the first image signal 31 and the second image signal 32 subjected to phase adjustment with reference to the first image signal 31.

In the similar manner to the first operation pattern, the image synthesizing unit 25 applies the first image signal 31 to a portion in which saturation does not occur. The image synthesizing unit 25 synthesizes the first image signal 31 and the second image signal 32 for a single frame F by an interpolation process for a saturated pixel and outputs the obtained WDR synthetic image signal 37. In the third operation pattern, the synthetic frame F0 is obtained by using a single frame F, so that the frame rate of the solid-state imaging device 50 becomes 30 fps that is the same as the frequency at which an image signal can be output from the pixel array.

In the third operation pattern, the solid-state imaging device 50 enables a WDR operation of maintaining the resolution as much as possible by a synthesizing process similar to the first operation pattern. Moreover, the solid-state imaging device 50 can maintain the frame rate equivalent to the output frequency of the image sensor 52 by a WDR operation of the third operation pattern. The solid-state imaging device 50 can obtain high-quality moving images by enabling high-speed imaging according to the output period of the image sensor 52 and enabling to ensure high image quality to a certain degree.

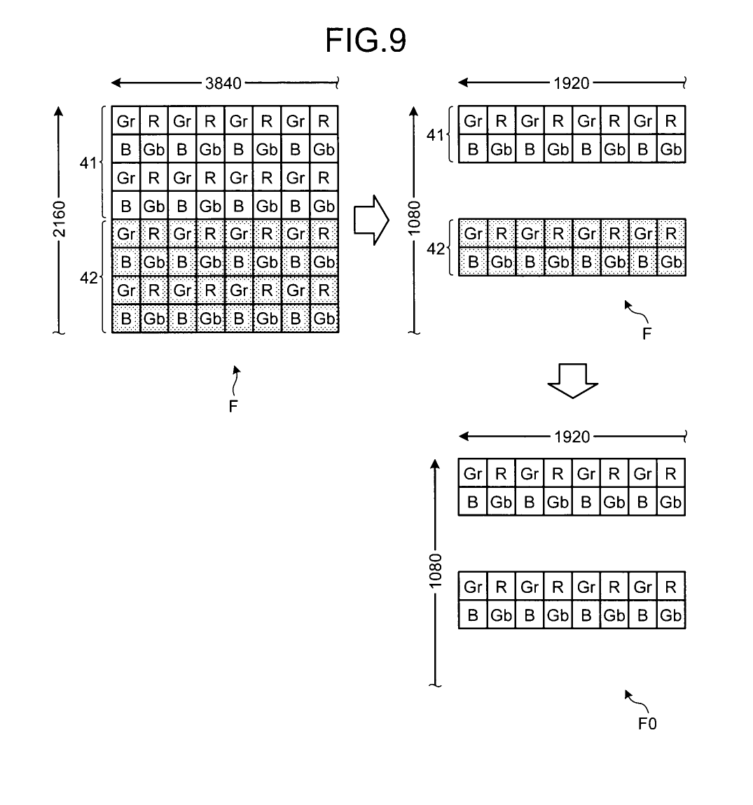

FIG. 9 is a diagram explaining a WDR operation in the fourth operation pattern. The fourth operation pattern is applied when the image size smaller than the number of pixels included in the pixel array is required and the frame rate higher than the frequency, at which an image signal can be output from the pixel array, is required. In this example, the image size required of a synthetic image is 1920×1080 pixels and the frame rate required of a synthetic image is 60 fps. The fourth operation pattern is, for example, suitable for capturing high-speed moving images for preview or the like.

The line-exposure selecting unit 24 outputs the line selection signal 35 for selecting the first exposure time and the second exposure time alternately every four lines. The image processing circuit 51 alternately sets the long-exposure pixels 41 for four lines and the short-time exposure pixels 42 for four lines. The image sensor 52 performs the long exposure and the short exposure every four lines according to the line selection signal 35. The image sensor 52 generates the first image signal 31 from the long-exposure pixels 41 and the second image signal 32 from the short-time exposure pixels 42.

Moreover, the line-exposure selecting unit 24 instructs to perform a binning process of reading out an image signal while regarding two pixels as one pixel in both the horizontal direction and the vertical direction, by the binning signal 54. The binning unit 53 performs a binning process in which the number of pixels is regarded as a half in the horizontal direction and the vertical direction, according to the binning signal 54.

The image sensor 52 generates the first image signal 31 and the second image signal 32 equivalent to the case of performing the long exposure and the short exposure every two lines by this binning process. In this example, the image sensor 52 outputs an image signal subjected to a binning process from 3840×2160 pixels to 1920×1080 pixels.

In a binning process in the horizontal direction, an image signal for the whole line is referred to, so that the output of the image sensor 52 is not normally accelerated. On the contrary, in a binning process in the vertical direction, the output of the image sensor 52 can be accelerated by reducing the number of read lines in a pseudo manner. The image sensor 52 can output an image signal at a frequency higher than the output frequency for the total pixel size by performing a binning process in the vertical direction. In this example, the image sensor 52 can output an image signal at 60 fps.

The image synthesizing unit 25 performs a synthesizing process by the fourth operation pattern according to the pattern identification signal 36 indicating the fourth operation pattern. The image synthesizing unit 25 multiplies a signal level of the second image signal 32 by a gain. The image synthesizing unit 25 synthesizes the first image signal 31 for two lines and the second image signal 32 multiplied by the gain for two lines alternately. Furthermore, in the similar manner to the second operation pattern, the image synthesizing unit 25 performs interpolation on a signal value of a saturated pixel.

After performing an interpolation process on a saturated pixel, the image synthesizing unit 25 synthesizes the first image signal 31 and the second image signal 32 for a single frame F and outputs the obtained WDR synthetic image signal 37. In the fourth operation pattern, because the synthetic frame F0 is obtained by using a single frame F, the frame rate of the solid-state imaging device 50 becomes 60 fps that is the same as the frequency at which an image signal can be output by the image sensor 52.

The solid-state imaging device 50 realizes high-speed imaging at a frame rate higher than the output frequency for the total pixel size in the image sensor 52 by a WDR operation in the fourth operation pattern. The solid-state imaging device 50 can perform moving image capturing faster than the third operation pattern. In this manner, the solid-state imaging device 50 can dynamically switch a degree to which the frame rate and the image quality are prioritized to suit the needs of a user of still images, moving images, high-speed moving images, or the like.

The image processing circuit 51 in the present embodiment is not limited to the case of enabling switching of a WDR operation between the first to fourth operation patterns. It is sufficient that the image processing circuit 51 performs a WDR operation by switching between at least two of the first to fourth operation patterns.

The camera module 10 that applies the solid-state imaging devices 11 and 50 according to the first and second embodiments may be an electronic device other than a digital camera, and may be, for example, a mobile terminal with camera or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a line-exposure selecting unit that selects any of a first exposure time and a second exposure time, which is shorter than the first exposure time, to be applied to each pixel forming a pixel array of an image sensor, for each line of the pixel array; and
an image synthesizing unit that performs interpolation on a signal value of a saturated pixel, in which saturation of output occurs with respect to incident light intensity among first pixels to which the first exposure time is applied, by using signal values of second pixels to which the second exposure time is applied, and obtains a synthetic image by synthesizing a first image signal obtained from the first pixels and a second image signal obtained from the second pixels, wherein
the line-exposure selecting unit is capable of switching a pattern of selecting the first exposure time and the second exposure time according to at least one of a frame rate required of the synthetic image and an image size required of the synthetic image.

2. The image processing device according to claim 1, wherein
in response to that an image size smaller than number of pixels included in the pixel array is required and a frame rate corresponding to a frequency, at which an image signal is capable of being output from the pixel array, is required, the line-exposure selecting unit selects the first exposure time and the second exposure time alternately every two lines, and
the image synthesizing unit synthesizes the first image signal and the second image signal subjected to phase adjustment with reference to the first image signal.

3. The image processing device according to claim 1, wherein
in response to that an image size smaller than number of pixels included in the pixel array is required and a frame rate higher than a frequency, at which an image signal is capable of being output from the pixel array, is required, the line-exposure selecting unit selects the first exposure time and the second exposure time alternately every four lines, and
the image synthesizing unit performs interpolation on a signal value of the saturated pixel by using signal values of the second pixels located around the saturated pixel, based on an image signal output from the image sensor after being subjected to a binning process.

4. The image processing device according to claim 1, wherein
in response to that an image size corresponding to number of pixels included in the pixel array is required and a frame rate corresponding to a half of a frequency, at which an image signal is capable of being output from the pixel array, is required, the line-exposure selecting unit selects the first exposure time for all lines in a first frame and selects the second exposure time for all lines in a second frame next to the first frame, and
the image synthesizing unit synthesizes the first image signal of the first frame and the second image signal of the second frame.

5. The image processing device according to claim 1, wherein
in response to that an image size corresponding to number of pixels included in the pixel array is required and a frame rate corresponding to a frequency, at which an image signal is capable of being output from the pixel array, is required, the line-exposure selecting unit selects the first exposure time and the second exposure time alternately every two lines, and
the image synthesizing unit performs interpolation on a signal value of the saturated pixel by using signal values of the second pixels located around the saturated pixel.

6. An image processing method comprising:
selecting any of a first exposure time and a second exposure time, which is shorter than the first exposure time, to be applied to each pixel forming a pixel array of an image sensor, for each line of the pixel array; and
performing interpolation on a signal value of a saturated pixel, in which saturation of output occurs with respect to incident light intensity among first pixels to which the first exposure time is applied, by using signal values of second pixels to which the second exposure time is applied, and obtaining a synthetic image by synthesizing a first image signal obtained from the first pixels and a second image signal obtained from the second pixels, wherein
a pattern of selecting the first exposure time and the second exposure time is switched according to at least one of a frame rate required of the synthetic image and an image size required of the synthetic image.

7. The image processing method according to claim 6, wherein
in response to that an image size smaller than number of pixels included in the pixel array is required and a frame rate corresponding to a frequency, at which an image signal is capable of being output from the pixel array, is required, the first exposure time and the second exposure time are selected alternately every two lines, and
the first image signal and the second image signal subjected to phase adjustment with reference to the first image signal are synthesized.

8. The image processing method according to claim 6, wherein
in response to that an image size smaller than number of pixels included in the pixel array is required and a frame rate higher than a frequency, at which an image signal is capable of being output from the pixel array, is required, the first exposure time and the second exposure time are selected alternately every four lines, and
interpolation is performed on a signal value of the saturated pixel by using signal values of the second pixels located around the saturated pixel, based on an image signal output from the image sensor after being subjected to a binning process.

9. The image processing method according to claim 6, wherein
in response to that an image size corresponding to number of pixels included in the pixel array is required and a frame rate corresponding to a half of a frequency, at which an image signal is capable of being output from the pixel array, is required, the first exposure time is selected for all lines in a first frame and the second exposure time is selected for all lines in a second frame next to the first frame, and
the first image signal of the first frame and the second image signal of the second frame are synthesized.

10. The image processing method according to claim 6, wherein
in response to that an image size corresponding to number of pixels included in the pixel array is required and a frame rate corresponding to a frequency, at which an image signal is capable of being output from the pixel array, is required, the first exposure time and the second exposure time are selected alternately every two lines, and
interpolation is performed on a signal value of the saturated pixel by using signal values of the second pixels located around the saturated pixel.

11. A solid-state imaging device comprising:
a lens unit that captures light from a subject and forms a subject image;
an image sensor that includes a pixel array and captures the subject image; and
an image processing device that performs a signal process on the subject image captured by the image sensor, wherein
the image processing device includes
a line-exposure selecting unit that selects any of a first exposure time and a second exposure time, which is shorter than the first exposure time, to be applied to each pixel forming a pixel array, for each line of the pixel array, and
an image synthesizing unit that performs interpolation on a signal value of a saturated pixel, in which saturation of output occurs with respect to incident light intensity among first pixels to which the first exposure time is applied, by using signal values of second pixels to which the second exposure time is applied, and obtains a synthetic image by synthesizing a first image signal obtained from the first pixels and a second image signal obtained from the second pixels, and
the line-exposure selecting unit is capable of switching a pattern of selecting the first exposure time and the second exposure time according to at least one of a frame rate required of the synthetic image and an image size required of the synthetic image.

12. The solid-state imaging device according to claim 11, wherein the image sensor has a configuration capable of selecting any of the first exposure time and the second exposure time to be applied to each pixel forming the pixel array, for each line.

13. The solid-state imaging device according to claim 11, wherein
in response to that an image size smaller than number of pixels included in the pixel array is required and a frame rate corresponding to a frequency, at which an image signal is capable of being output from the pixel array, is required, the line-exposure selecting unit selects the first exposure time and the second exposure time alternately every two lines, and
the image synthesizing unit synthesizes the first image signal and the second image signal subjected to phase adjustment with reference to the first image signal.

14. The solid-state imaging device according to claim 13, wherein
the image sensor includes a binning unit that performs a binning process,
the line-exposure selecting unit instructs the binning unit to perform the binning process,
the binning unit performs the binning process of reading out an image signal while regarding a region including two pixels juxtaposed in a horizontal direction in the pixel array as one light receiving surface, according to an instruction from the line-exposure selecting unit, and
the image synthesizing unit performs interpolation on a signal value of the saturated pixel by using signal values of the second pixels located around the saturated pixel, based on an image signal output from the image sensor after being subjected to the binning process.

15. The solid-state imaging device according to claim 11, wherein
the image sensor includes a binning unit that performs a binning process,
in response to that an image size smaller than number of pixels included in the pixel array is required and a frame rate higher than a frequency, at which an image signal is capable of being output from the pixel array, is required, the line-exposure selecting unit instructs the binning unit to perform the binning process and selects the first exposure time and the second exposure time alternately every four lines, and
the image synthesizing unit performs interpolation on a signal value of the saturated pixel by using signal values of the second pixels located around the saturated pixel, based on an image signal output from the image sensor after being subjected to the binning process.

16. The solid-state imaging device according to claim 15, wherein the binning unit performs the binning process of reading out an image signal while regarding a region including two pixels juxtaposed to each other as one light receiving surface in both a horizontal direction and a vertical direction of the pixel array, according to an instruction from the line-exposure selecting unit.

17. The solid-state imaging device according to claim 11, wherein
in response to that an image size corresponding to number of pixels included in the pixel array is required and a frame rate corresponding to a half of a frequency, at which an image signal is capable of being output from the pixel array, is required, the line-exposure selecting unit selects the first exposure time for all lines in a first frame and selects the second exposure time for all lines in a second frame next to the first frame, and
the image synthesizing unit synthesizes the first image signal of the first frame and the second image signal of the second frame.

18. The solid-state imaging device according to claim 11, wherein
in response to that an image size corresponding to number of pixels included in the pixel array is required and a frame rate corresponding to a frequency, at which an image signal is capable of being output from the pixel array, is required, the line-exposure selecting unit selects the first exposure time and the second exposure time alternately every two lines, and
the image synthesizing unit performs interpolation on a signal value of the saturated pixel by using signal values of the second pixels located around the saturated pixel.
